(19) United States
(12) Patent Application Publication
(10) Pub. No.: US 2022/0153613 A1
(43) Pub. Date: May 19, 2022

(54) ULTRA-HIGH ALKALINE ELECTROLYZED WATER GENERATION SYSTEM

(71) Applicant: CELCIUS CORP., Bloomfield Hills, MI (US)

(72) Inventor: Rakesh Raghavendra Katragadda, Bloomfield Hills, MI (US)

(21) Appl. No.: 17/100,153

(22) Filed: Nov. 20, 2020

Related U.S. Application Data
(60) Provisional application No. 63/114,620, filed on Nov. 17, 2020.

(51) Int. Cl. C02F 1/461

(52) U.S. Cl. CPC C02F 1/4618; C02F 1/46109; C02F 2001/4619; C02F 2201/46115; C02F 2201/4617; C02F 2201/46145; C02F 2209/06; C02F 2001/46133

(57) ABSTRACT

An ultra-high alkaline electrolyzed water generation system with a pH 12.5-13.5 pH is provided. The ultra-high alkaline electrolyzed water generation system includes an electrolytic cell, a first tank, a second tank, a water tank, and a plurality of flowlines. The ultra-high alkaline electrolyzed water generation system is cost-effective. The ultra-high alkaline electrolyzed water generation system enables production of ultra-high alkaline electrolyzed water at faster rate for commercial and industrial applications with a large shelf life and can be stored in containers for later use. The invention also provides an electrolytic cell. The electrolytic cell includes a cathode chamber, an anode chamber, and a cation permselective membrane. The electrolytic cell enables production of the ultra-high alkaline electrolyzed water. The ultra-high alkaline electrolyzed water with a configurable pH range has the ability to sterilize, clean and disinfect without the use of harsh chemicals.

### CROSS-REFERENCE TO RELATED APPLICATIONS

This application claims the priority benefit of U.S. Provisional Patent Application Ser. No. 63/114,620, filed Nov. 17, 2020, which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

Embodiments of the present invention relate to system for generating ultra-high alkaline electrolyzed water, and more particularly, to an ultra-high alkaline electrolyzed water generation system of pH greater than 12.5 for production of ultra-high alkaline electrolyzed water for disinfecting and cleaning purpose.

### BACKGROUND

Electrolyzed water is produced by the electrolysis of ordinary tap water containing dissolved sodium chloride. Huang et al., 2007, in their paper, application of electrolyzed water in the food industry, disclosed that electrolyzed water is emerging as an environmentally friendly antimicrobial treatment. The electrolyzed water is produced by electrolysis of a dilute salt solution, and the reaction products include sodium hydroxide (NaOH) and hypochlorous acid. Three forms of the solution can be produced, an acidic form, a neutral pH form, and an alkaline form.

Studies have revealed, an alkaline electrolyzed water is as effective in removing organic matter as conventional treatments, making this technology ideal for general use in retail food establishments. The alkaline electrolyzed water also functions as a powerful oxidant that kills 99.99% of bacteria, fungi, and viruses. The alkaline electrolyzed water has faster reaction rates than household bleach, being approximately 50 to 100 times more effective. Hence, the ultra-high alkaline electrolyzed water may prove to be an ideal disinfectant.

Researchers claim that alkaline electrolyzed water provides great benefits that regular tap or bottled water lack. The alkaline electrolyzed water restores pH balance in the body as alkaline electrolyzed water carries higher pH levels than regular bottled water which contributes to reducing the acidity levels in the human body. There are a lot of commercially available machines that can generate alkaline water in the range of pH 9.5 to 11.5.

Existing alkaline electrolyzed water is produced or generated by an electrolytic device or cell. The electrolytic cell is a kind of electrochemical cell. The electrolytic cell is often used to decompose chemical compounds, in a process called electrolysis. It is also common in the art to use a separate method for a disinfecting and sanitizing solution and a separate method for a cleaning solution. Hypochlorous acid is used for creating a disinfecting and sanitizing solution and alkaline water for cleaning purposes.

However, existing technological designs and the methods of manufacture thereof are associated with the electrolytic devices or alkaline electrolysis for drinking water and other normal household applications and there is no use of them in industrial or commercial applications. Existing technologies also have severe limitations as the alkaline water that is generated has a short shelf life of less than 60 days. In order for the commercial systems to function, there is a need for a shelf-life of at least 2 to 3 years so that the water can be stored in bottles and transported. Hence, there is a severe limitation to alkaline water production systems.

Hence, there is a need for an efficient and cost effective ultra-high alkaline electrolyzed water generation system at faster rate.

### SUMMARY

In accordance with an embodiment of the present invention, a commercial grade, ultra-high alkaline (i.e., pH greater or equal to about 12.5 to about 13.5) electrolyzed water generation system is provided that can be used commercially for sanitizing, disinfecting and/or cleaning either in bottles with a minimum shelf life of 2 years or as a local Clean in Place for on-site generation. The ultra-high alkaline electrolyzed water generation system includes at least one electrolytic cell configured to produce ultra-high alkaline electrolyzed water. The at least one electrolytic cell includes a cathode chamber comprising at least one cathode plate and configured to generate hydroxyl ions (OH⁻) and thereby producing the ultra-high alkaline electrolyzed water. The at least one electrolytic cell also includes an anode chamber comprising at least one anode plate and configured to electrolyze water to generate oxygen (O₂) and hydrogen ions (H⁺) thereby producing acidic electrolyzed water. The at least one electrolytic cell also includes a cation permselective membrane separating the cathode chamber and the anode chamber, and configured to allow passage of cations from the anode chamber to the cathode chamber. The ultra-high alkaline electrolyzed water generation system includes a first tank fluidically coupled to the anode chamber of the electrolytic cell, and configured to supply potassium carbonate as a feed to the anode chamber of the electrolytic cell at a first predefined flow rate, and collect supplied potassium carbonate. The ultra-high alkaline electrolyzed water generation system includes a second tank fluidically coupled to the cathode chamber of the electrolytic cell, and configured to collect the ultra-high alkaline electrolyzed water produced in the cathode chamber of the electrolytic cell, and recirculate collected ultra-high alkaline electrolyzed water at a second predefined flow rate to the cathode chamber to adjust pH of the ultra-high alkaline electrolyzed water produced in the cathode chamber. The ultra-high alkaline electrolyzed water generation system also includes a water tank fluidically coupled to the cathode chamber and the first tank and configured to feed water at a third predefined flow rate. The ultra-high alkaline electrolyzed water generation system also includes a plurality of flowlines configured to establish a fluidic connection between the electrolytic cell, the first tank, the second tank, and the water tank. The ultra-high alkaline water produced by the ultra-high alkaline water generation system is used for cleaning and disinfecting purposes.

In accordance with another embodiment of the present invention, an electrolytic cell is provided. The electrolytic cell includes a cathode chamber comprising at least one cathode plate and configured to generate hydroxyl ions (OH—) and thereby producing ultra-high alkaline electrolyzed water. The electrolytic cell includes an anode chamber comprising at least one anode plate and configured to electrolyze water to generate oxygen gas (O2) and hydrogen ions (H+) thereby producing acidic electrolyzed water. The electrolytic cell also includes a cation permselective membrane separating the cathode chamber and the anode chamber and configured to allow passage of cations from the anode chamber to the cathode chamber. The electrolytic cell enables production of the ultra-high alkaline electrolyzed water.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a block diagram of an ultra-high alkaline electrolyzed water generation system 100, in accordance with an embodiment of the present disclosure.

FIG. 2 illustrates a block diagram of the ultra-high alkaline electrolyzed water generation system comprising multiple electrolytic cells, in accordance with an embodiment of the present disclosure.

FIG. 3 illustrates a block diagram of an electrolytic cell 500, in accordance with an embodiment of the present disclosure.

FIG. 4 illustrates a representation of mechanism of disinfecting using ultra-high alkaline electrolyzed water, in accordance with an embodiment of the present disclosure.

FIGS. 5A-5C illustrates the effect of the ultra-alkaline water on killing lentivirus.

Further, those skilled in the art will appreciate that elements in the figures are illustrated for simplicity and may not have necessarily been drawn to scale. Furthermore, in terms of the method steps, chemical compounds, and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

As described herein, the present invention will generate ultra-high pH water of pH about 12.5 to about 13.5 that can be used as a combined solution for sanitizing, disinfection and cleaning.

Embodiments of the present invention relates to an ultra-high alkaline electrolyzed water generation system 100. An ultra-high alkaline electrolyzed water produced by the ultra-high alkaline electrolyzed water generation system 100 may serve as a disinfectant, sanitization, and/or cleaning agent.

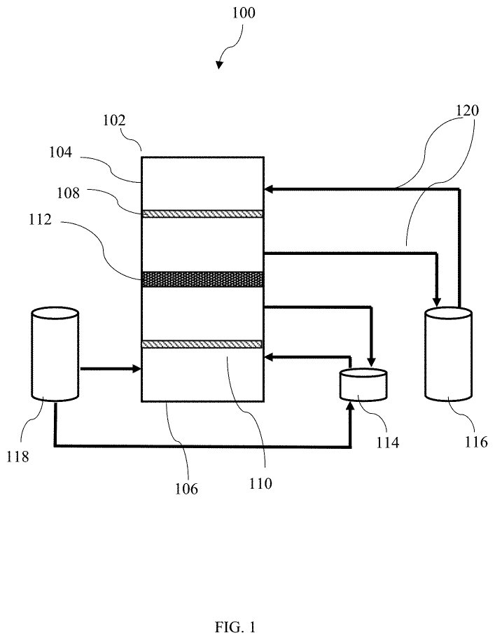

FIG. 1 illustrates a block diagram of the ultra-high alkaline electrolyzed water generation system, in accordance with an embodiment of the present disclosure.

In an embodiment, the ultra-high alkaline electrolyzed water generation system 100 includes at least one electrolytic cell 102 configured to produce ultra-high alkaline electrolyzed water. The at least one electrolytic cell 102 includes a cathode chamber 104 comprising at least one cathode plate 108 and configured to generate hydroxyl ions (OH⁻) and thereby producing the ultra-high alkaline electrolyzed water. The at least one electrolytic cell 102 also includes an anode chamber 106 comprising at least one anode plate 110 and configured to electrolyze water to generate oxygen (O₂) and hydrogen ions (H⁺) thereby producing acidic electrolyzed water. The at least one electrolytic cell 102 also includes a cation permselective membrane 112 separating the cathode chamber 104 and the anode chamber 106, and is configured to allow passage of cations from the anode chamber 106 to the cathode chamber 104. The cations comprise potassium ions. The cathode plate 108 and the anode plate 110 are fabricated with a titanium alloy having a platinum plating.

The cation permselective membrane 112 comprises one of: a homogenous sheet or a heterogenous sheet with cation exchange groups. The cation exchange groups comprise acidic groups selected from a group consisting of: sulphonic groups, carboxylic phosphoric groups, or a combination thereof. The electrolytic cell 102 is applied with direct current (DC) voltage for carrying out the electrolysis.

As used herein the term ‘cathode plate’ refers to a metallic electrode through which current flows out in a polarized electrical device. As used herein the term ‘anode plate’ refers to an electrode in a polarized electrical device through which current flows in from an outside circuit. As used herein, the term ‘cation permselective membrane’ refers to a cation-exchange material that allows only cations to enter and pass through.

Temperature of feed solution inside the anode chamber 106 is maintained at temperatures greater than ambient temperatures throughout electrolysis process. Generally, the temperature of the feed solution is maintained between about 70° C. to about 110° C.; about 80° C. to about 100° C.; at about 90° C.; etc. Elevated temperature of the feed solution may depend on concentration of alkali metal bicarbonate (potassium bicarbonate) in the feed solution, and boiling point of the feed solution. Preferably, the temperature of the feed solution is at or near the boiling point of the feed solution. The contents of the anode chamber 106 is maintained at elevated temperatures, by conventional heater elements.

In an embodiment, the ultra-high alkaline electrolyzed water generation system 100 includes a first tank 114 fluidically coupled to the anode chamber 106 of the electrolytic cell 102. The first tank 114 is configured to supply potassium carbonate as a feed to the anode chamber 106 of the electrolytic cell 102 at a first predefined flow rate, and collect supplied potassium carbonate. The potassium carbonate is formed by adding 800 grams of food grade potassium carbonate in 5 liters of filtered water. The first predefined flow rate for supplying potassium bicarbonate to the anode chamber 106 is one of; a linear rate or a non-linear rate. For example, a first flow rate may range from about 1 L/minute to about 3 L/minute; about 1.5 L/minute to about 2.5 L/minute; about 1.75 L/minutes to about 2.75 L/minute, or substantially 2 L/minute. The potassium carbonate is a strong electrolyte used for producing the ultra-high alkaline electrolyzed water. The potassium carbonate is recirculated continually until the density of the solution falls below 18% upon which time the food grade potassium carbonate is replaced as above.

As used herein the term ‘electrolyte’ refers to a substance that produces an electrically conducting solution when dissolved in a polar solvent, such as water. The dissolved electrolyte separates into cations and anions, which disperse uniformly through the solvent.

In an embodiment, the ultra-high alkaline electrolyzed water generation system 100 includes a second tank 116 fluidically coupled to the cathode chamber 104 of the electrolytic cell 102. The second tank 116 is configured to collect the ultra-high alkaline electrolyzed water produced in the cathode chamber 104 of the electrolytic cell 102 and recirculate collected ultra-high alkaline electrolyzed water at a second predefined flow rate to the cathode chamber 104 to adjust pH of the ultra-high alkaline electrolyzed water produced in the cathode chamber 104. For example, as the number of recirculation cycles increases, the pH of the ultra-high alkaline water increases. In one embodiment, when the ultra-high alkaline electrolyzed water is recirculated in the cathode chamber more than or equal to five times, the pH is increased to about 13.5. The cycle number may be adjusted to achieve the desired pH of the water. The second predefined flow may be between about 0.25 L/second to about 2.5 L/second; about 0.5 L/second to about 2 L/second; about 0.75 L/second to about 1.75 L/second; about 1 L/second to about 1.5 L/second; etc. The pH of the ultra-high alkaline electrolyzed water ranges between 12.5 to 13.5. As used herein the term ‘ultra-high alkaline electrolyzed water’ refers to water which is obtained on the cathode side by the electrolysis of tap water. The recirculation of the ultra-high alkaline electrolyzed water at the second predefined flow rate to the cathode chamber 104 is carried by a cathode water circulation system. As used herein the term ‘cathode water’ refers to the ultra-high alkaline electrolyzed water produced at the cathode chamber 104 of the electrolytic cell 102.

In an embodiment, the ultra-high alkaline electrolyzed water generation system 100 also includes a water tank 118 fluidically coupled to the cathode chamber 104 and the first tank 114 and configured to feed water at a third predefined flow rate. For example, a third predefined flow rate may range from about 1 L/minute to about 3 L/minute; about 1.5 L/minute to about 2.5 L/minute; about 1.75 L/minutes to about 2.75 L/minute, or substantially 2 L/minute. The water in the feed enables electrolysis of water, thereby enabling production of the ultra-high alkaline electrolyzed water.

In an embodiment, the ultra-high alkaline electrolyzed water generation system 100 also includes a plurality of flowlines 120 configured to establish a fluidic connection between the electrolytic cell 102, the first tank 114, the second tank 116, and the water tank 118. The plurality of flowlines comprises one or more flow sensors 122 (not shown in FIG. 1) configured to detect a plurality of parameters. The plurality of parameters includes, but is not limited to: pressure, flow rate, leakage, and/or corrosion.

In one embodiment, the flow sensors 122 detect pressure of gases while removal of gases though the flowlines 120, which are produced during reactions at cathode plate 108 and anode plate 110.

The plurality of flowlines also includes a plurality of pumps 124 (not shown in FIG. 1) located between the plurality of flowlines 120, and configured to circulate the water, the potassium carbonate, and the ultra-high alkaline electrolyzed water to the electrolytic cell 102. In one embodiment, the plurality of pumps 124 include a metering pump. As used herein, the term ‘metering pump’ refers to a pump which moves a precise volume of liquid in a specified time period providing an accurate volumetric flow rate.

The plurality of flowlines 120 also comprises a plurality of solenoid valves 126 (not shown in FIG. 1) mounted between the plurality of flowlines 120, and configured to regulate flow of the water, the potassium carbonate, and the ultra-high alkaline electrolyzed water. As used herein, the term ‘solenoid valves’ refers to valves which are used to close, open, dose, distribute, or mix the flow of gas or liquid in a pipe. The solenoid valves 120 are electromechanically operated valves.

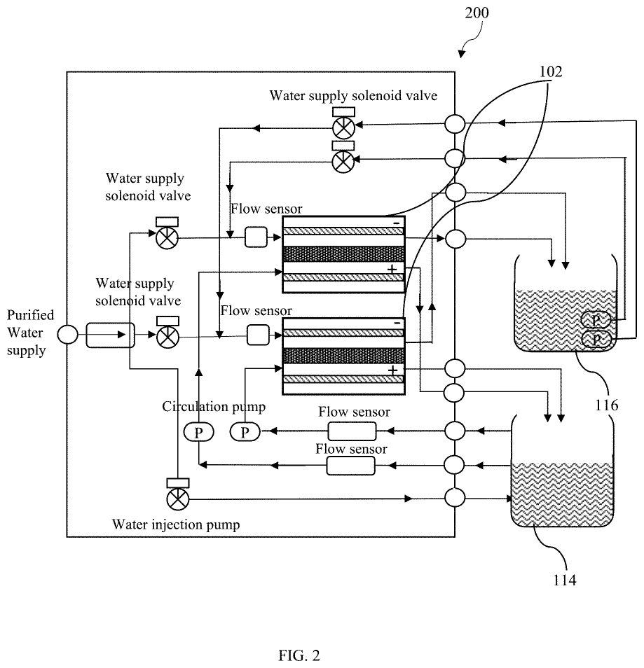

FIG. 2 illustrates a block diagram of the ultra-high alkaline electrolyzed water generation system 100 comprising multiple electrolytic cells 102, in accordance with an embodiment of the present disclosure. The ultra-high alkaline electrolyzed water generation system 100 includes multiple pairs of the cathode plate 108 and the anode plate 110, and the cation permselective membrane 112 separating the pair of the cathode plate 108 and the anode plate 110. As a result, ratio of an electrolyzed area to total surface area of electrode plate (cathode plate, anode plate) is increased, thereby increasing production of ultra-high alkaline electrolyzed water, and decreasing size of the electrolytic cell 102.

Reactions carried in the electrolytic cell 102:

H₂O+K₂CO₃ [symbol] H₂O+2K⁺+CO₃²⁻

The water is electrolyzed at the anode plate 110 to yield oxygen gas and hydrogen ion which then reacts with carbonate ion present in a feed solution to yield bicarbonate ion. The bicarbonate ion in turn reacts with more hydrogen ions to yield carbonic acid. Thus, in the anode chamber, oxygen gas and carbon dioxide gas are given off, and the feed solution is constantly renewed with a new supply of carbonates.

Chemical reactions carried at anode plate 110 in an anode chamber 106 of the electrolytic cell 102:

[symbol] 2H₂O+2CO₃²⁻−2e

carbonate ion

[symbol] 2H₂CO₃+2O

carbonic acid oxygen generator

[symbol] 2HCO₃⁻+2H⁺+O₂

bicarbonate ion acid oxygen gas

[symbol] 2CO₂+2OH⁻+2H⁺O₂

carbon dioxide gas neutral

[symbol] (2H₂O)

At the cathode plate 108, the water is likewise electrolyzed yielding hydrogen gas and hydroxyl ions. The sodium ions from the anode chamber are attracted by the cathode plate 108, passed through the cation permselective membrane 112, and reacted in the cathode chamber 104. The sodium ions react with the generated hydroxyl ions to yield a caustic solution (ultra-high alkaline electrolyzed water) which is continuously or intermittently withdrawn. The water is supplied as required in the cathode chamber 104 for makeup of contents in the cathode chamber 104.

Chemical reactions carried at cathode plate 108 in a cathode chamber 104 of the electrolytic cell 102:

[symbol] 2H₂O+2K⁺+2^{e}

[symbol] 2H₂O—2K

Potassium root

[symbol] 2KOH+2H+(H2O2/—OH)

Generator hydrogen (hydrogen peroxide/hydroxyl radical)

[symbol] 2K⁺+2OH⁻(H3O2-)+H2+cluster refinement

Ultra-high alkaline hydroxyl ionized dissolved hydrogen, hydrogen gas

(hydrophilic/lipophilic: surfactant action)

In another embodiment, an electrolytic cell 300 is provided. The electrolytic cell 300 is configured to produce ultra-high alkaline electrolyzed water by carrying out electrolysis of water.

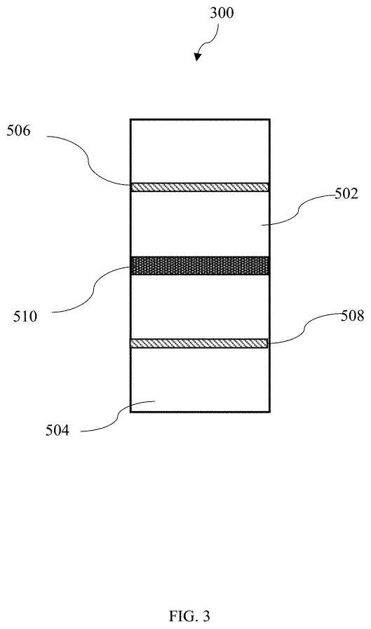

FIG. 3 illustrates a block diagram of the electrolytic cell 300, in accordance with an embodiment of the present disclosure.

The electrolytic cell 300 includes a cathode chamber 302 comprising at least one cathode plate 306 and configured to generate hydroxyl ions (OH—) and thereby producing ultra-high alkaline electrolyzed water. pH of the ultra-high alkaline electrolyzed water produced in the cathode chamber 302 ranges between pH about 12.5 to about 13.5.

In an embodiment, the electrolytic cell 300 includes an anode chamber 504 comprising at least one anode plate 308 and configured to electrolyze water to generate oxygen gas (O2) and hydrogen ions (H+) thereby producing acidic electrolyzed water. The cathode plate 306 and the anode plate 308 are fabricated with a titanium alloy having a platinum plating.

In an embodiment, the electrolytic cell 300 also includes a cation permselective membrane 310 separating the cathode chamber 302 and the anode chamber 304. The cation permselective membrane 310 is configured to allow passage of cations from the anode chamber 304 to the cathode chamber 302. The cations include sodium ions. The cation permselective membrane 310 comprises one of: a homogenous sheet or a heterogenous sheet provided with cation exchange groups. The cation exchange groups comprise acidic groups selected from a group consisting of: sulphonic groups, carboxylic phosphoric groups, or a combination thereof.

In one embodiment, the cation permselective membrane 310 includes Nafion® membrane manufactured by E. I. du Pont de Nemours and Company®, Wilmington. The Nafion® membrane contains perfluoro sulfonic acid groups as cation exchange ally inert to the electrolytic process conditions.

In another embodiment, the cation permselective membrane 310 includes a sulfonated copolymer of a mono-vinyl aromatic compound and a linear aliphatic polyene hydrocarbon.

The electrolytic cell 300 is applied with DC voltage to produce the ultra-high alkaline water. As used herein, the term ‘DC voltage’ refers to one directional or unidirectional flow of electric charge. Direct current may flow through a conductor such as a wire, but can also flow through semiconductors, insulators, or even through a vacuum as in electron or ion beams.

The present invention provides the ultra-high alkaline electrolyzed water generation system 100 and the electrolytic cell 300 which helps in production of the ultra-high alkaline electrolyzed water. The ultra-high alkaline electrolyzed water generation system 100 is cost effective and produces the ultra-high alkaline electrolyzed water at faster rate, as the multiple electrolytic cells may be provided in the ultra-high alkaline electrolyzed water generation system 100. The electrolytic cell 300 enables production of the ultra-high alkaline electrolyzed water. The ultra-high alkaline electrolyzed water is used as a neutralizing agent to neutralize acidic solutions without adding alkalis that may lead to exothermic reactions or waste bye-products in effluent treatment. In laboratory tests, the ultra-high alkaline electrolyzed water has been shown to kill bacteria, H1N1, and Norovirus, hence, the ultra-high alkaline electrolyzed water is also used as a disinfecting agent. The ultra-high alkaline electrolyzed water is may serve as a degreasing agent since its ultra-high alkaline properties are similar to soap.

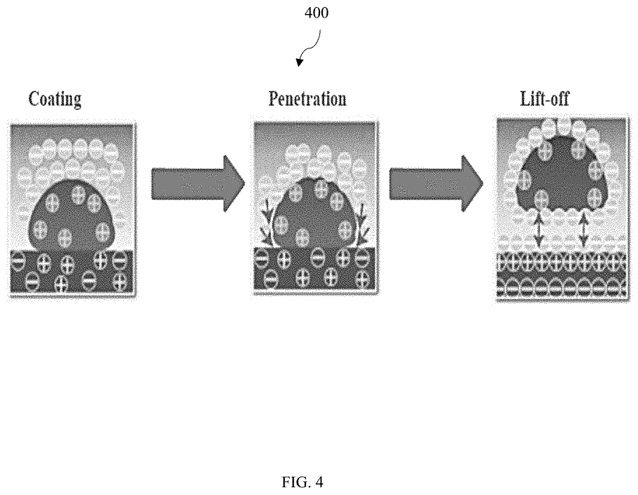

FIG. 4 illustrates a representation of mechanism 400 of disinfecting using ultra-high alkaline electrolyzed water, in accordance with an embodiment of the present disclosure. The ultra-high alkaline electrolyzed water with a configurable pH range has the ability to sterilize, clean, and disinfect without the use of harsh chemicals. Ultra-high alkaline water contains a large amount of hydroxyl group (OH—).

Mechanism of Cleaning or Disinfecting Using the Ultra-High Alkaline Electrolyzed Water:

The ultra-high alkaline electrolyzed water coats a surface of an object to be cleaned and penetrates into toughest of dirt particles or microbes which include both viruses and bacteria at the nano surface level. The dirt particles and/or microbes are emulsified. The ultra-high alkaline electrolyzed water carries the emulsified dirt particles with floating water molecules for cleaning and, being very high pH, will degrade or destroy the cell structure and protein structure of a virus. Furthermore, negative charges on the surface of an object to be cleaned and the hydroxyl groups (OH—) of the ultra-high alkaline water repel each other, resulting in a lifting-off of the particles from the surface of the object. The floating molecules are broken down into smaller pieces and are wiped out off the surface of the object.

To demonstrate the effectiveness of virus killing, the ultra-alkaline water was tested.

### Example 1

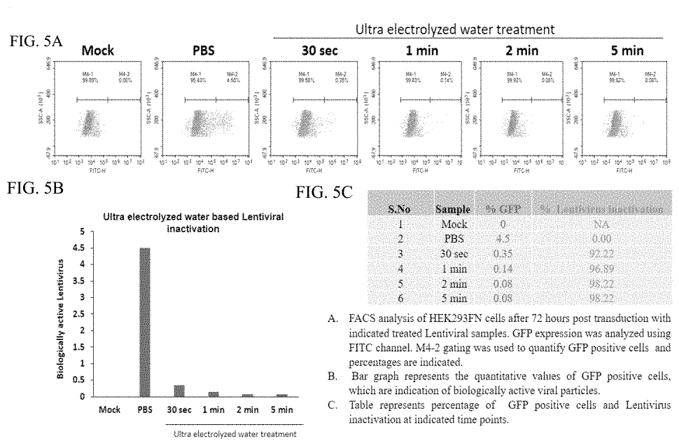

Inactivation of virus: Total 15 μl of Lenti-GFP particles (5×105 TU/ml) was incubated with 5 μl of Ultra electrolysed water (pH 13.2) for indicated time points at room temperature, as shown in FIG. 5A. After incubation, biologically active viral particles were titrated against HEK293FN cells.

Titration of biologically active Lentivirus particles: Either PBS treated or Ultra electrolysed water treated viral samples were added to a single well of 24 well plate containing 40,000 HEK293FN cells in 500 ul complete medium with 1× transdux (Systsem Biosciences). Viral titration was carried out by scoring GFP positive cells using FACS (Fluorescence Activated Cell sorting) analysis at 72 hours post transduction. Note that each GFP positive cell is an indication of biologically active virus.

Results: PBS treated Lenti-GFP served as positive control for active viral particles and showed 4.5% GFP positive cells. Ultra electrolysed water treated viral samples showed drastic decrease in the percentage of GFP positive cells at 30 sec (0.35%), 1 min (0.14%), 2 min (0.08%) and 5 min (0.08%), as shown in FIG. 5B.

Ultra-high alkaline water (pH 13.2) treatment decreases Lentivirus biological activity by 98.22% at 2 minutes. As indicated in FIG. 5C, 30 seconds incubation inactivated virus by 92.22%.

NOTE: Ultra-high alkaline water treatment alone (5 μl in 500 μl medium) did not show any effect on HEK293FN cell growth. Experiment was performed once with single sample.

While specific language has been used to describe the invention, any limitations arising on account of the same are not intended. As would be apparent to a person skilled in the art, various working modifications may be made to the method in order to implement the inventive concept as taught herein.

As used in the description and claims, the singular form “a”, “an” and “the” include both singular and plural references unless the context clearly dictates otherwise. For example, the term “ion” may include, and is contemplated to include, a plurality of ions. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An ultra-high alkaline electrolyzed water generation system, comprising:
at least one electrolytic cell configured to produce ultra-high alkaline electrolyzed water, wherein the at least one electrolytic cell comprises:
a cathode chamber comprising at least one cathode plate and configured to generate hydroxyl ions (OH⁻) and thereby producing the ultra-high alkaline electrolyzed water;
an anode chamber comprising at least one anode plate and configured to electrolyze water to generate oxygen (O₂) and hydrogen ions (H⁺) thereby producing acidic electrolyzed water;
a cation permselective membrane separating the cathode chamber and the anode chamber, and configured to allow passage of cations from the anode chamber to the cathode chamber;
a first tank fluidically coupled to the anode chamber of the electrolytic cell, and configured to supply potassium carbonate as a feed to the anode chamber of the electrolytic cell at a first predefined flow rate, and collect supplied potassium carbonate;
a second tank fluidically coupled to the cathode chamber of the electrolytic cell, and configured to collect the ultra-high alkaline electrolyzed water produced in the cathode chamber of the electrolytic cell, and recirculate collected ultra-high alkaline electrolyzed water at a second predefined flow rate to the cathode chamber to adjust pH of the ultra-high alkaline electrolyzed water produced in the cathode chamber;
a water tank fluidically coupled to the cathode chamber and the first tank and configured to feed water at a third predefined flow rate; and
a plurality of flowlines configured to establish a fluidic connection between the electrolytic cell, the potassium carbonate tank, the water tank, and the ultra-high alkaline electrolyzed water storage tank.

2. The ultra-high alkaline electrolyzed water generation system of claim 1, wherein pH of the ultra-high alkaline water ranges between about 12.5 to about 13.5.

3. The ultra-high alkaline electrolyzed water generation system of claim 1, wherein the output water can be bottled for later use to be used for cleaning and disinfection.

4. The ultra-high alkaline electrolyzed water generation system of claim 1, wherein the cathode plate and the anode plate are fabricated with a titanium alloy having a platinum plating.

5. The ultra-high alkaline electrolyzed water generation system of claim 1, wherein the cation permselective membrane comprises one of: a homogenous sheet with cation exchange groups or a heterogenous sheet with cation exchange groups.

6. The ultra-high alkaline electrolyzed water generation system of claim 5, wherein the cation exchange groups comprise acidic groups selected from a group consisting of: sulphonic groups, carboxylic phosphoric groups, or a combination thereof.

7. The ultra-high alkaline electrolyzed water generation system of claim 1, wherein the first predefined flow rate for supplying potassium bicarbonate to the anode chamber is one of: a of a linear rate or a non-linear rate.

8. The ultra-high alkaline electrolyzed water generation system of claim 1, wherein the plurality of flowlines comprises one or more flow sensors configured to detect a plurality of parameters.

9. The ultra-high alkaline electrolyzed water generation system of claim 8, wherein the plurality of parameters comprises pressure, flow rate, leakage, corrosion, or a combination thereof.

10. The ultra-high alkaline electrolyzed water generation system of claim 1, wherein a plurality of pumps is located between the plurality of flowlines, and configured to circulate the water, the potassium carbonate, and the ultra-high alkaline electrolyzed water to the electrolytic cell.

11. The ultra-high alkaline electrolyzed water generation system of claim 1, wherein a plurality of solenoid valves is mounted between the plurality of flowlines, and configured to regulate flow of the water, the potassium carbonate, and the ultra-high alkaline electrolyzed water.

12. The ultra-high alkaline electrolyzed water generation system of claim 1, wherein the electrolytic cell is applied with DC voltage for carrying out the electrolysis.

13. An electrolytic cell, comprising:
a cathode chamber comprising at least one cathode plate and configured to generate hydroxyl ions (OH—) and thereby producing ultra-high alkaline water;
an anode chamber comprising at least one anode plate and configured to electrolyze water to generate oxygen gas (O2) and hydrogen ions (H+) thereby producing acidic electrolyzed water; and
a cation permselective membrane separating the cathode chamber and the anode chamber and configured to allow passage of cations from the anode chamber to the cathode chamber.

14. The electrolytic cell of claim 13, wherein pH of the ultra-high alkaline water ranges between about 12.5 to about 13.5

15. The electrolytic cell of claim 13, wherein the cation permselective membrane comprises one of: a homogenous sheet provided with cation exchange groups or a heterogenous sheet provided with cation exchange groups.

16. The electrolytic cell of claim 15, wherein the cation exchange groups comprise acidic groups selected from a group consisting of: sulphonic groups, carboxylic phosphoric groups, or a combination thereof.

17. The electrolytic cell of claim 13, wherein the cathode plate and the anode plate are made up of titanium alloy with platinum plating.

18. The electrolytic cell of claim 13, wherein the electrolytic cell is applied with DC voltage to produce the ultra-high alkaline water.
